(19) United States
(12) Patent Application Publication
(10) Pub. No.: US 2023/0296156 A1
(43) Pub. Date: Sep. 21, 2023

(54) DAMPING VALVE AND SHOCK ABSORBER

(71) Applicant: KYB Corporation, Tokyo (JP)

(72) Inventors: Tomoyasu ABE, Tokyo (JP); Yoshifumi KOBAYASHI, Tokyo (JP); Toshihiro MORI, Tokyo (JP)

(73) Assignee: KYB Corporation, Tokyo (JP)

(21) Appl. No.: 18/018,183

(22) PCT Filed: Aug. 17, 2021
(86) PCT No.: PCT/JP2021/030034

§ 371 Date: Jan. 26, 2023

(30) Foreign Application Priority Data
Sep. 29, 2020 (JP) 2020-163068

(51) Int. Cl. F16F 9/348; F16K 17/04

(52) U.S. Cl. CPC F16F 9/3485; F16K 17/04

(57) ABSTRACT

A damping valve includes: a disk with a port and a valve seat surrounding the port; a leaf valve that opens and closes the port by causing the front side to sit on and leave the valve seat; a tubular housing provided on the back side of the leaf valve; an annular spool that abuts on the back of the leaf valve and is slidably inserted into the inner circumference of the housing to form a back pressure chamber that causes back pressure to act on the leaf valve inwardly together with the housing; an annular spring support portion that is located on the back side of the leaf valve, faces the inside of the back pressure chamber, and has a smaller outer diameter than an inner diameter of the spool; and an annular leaf spring that is interposed between one end of the spool that is an opposite side end of the leaf valve and the spring support portion and presses the spool in a direction of abutting on the leaf valve.

### TECHNICAL FIELD

The present invention relates to a damping valve and a shock absorber.

### BACKGROUND ART

A damping valve is used for a variable damping valve that is interposed between a vehicle body and an axle and makes damping force of a shock absorber variable, for example, as disclosed in JP2014-173714 A. Such a damping valve includes, for example, an annular disk with a port leading from a cylinder to a reservoir of the shock absorber, a leaf valve that opens and closes the port, a back pressure chamber provided on the back side of the leaf valve that is the opposite side of the disk, a pilot passage that causes upstream of the port to communicate with the reservoir, an orifice provided in the pilot passage, a control valve provided downstream of the orifice in the pilot passage, and a solenoid that adjusts valve opening pressure of the control valve, and introduces secondary pressure between the orifice of the pilot passage and the control valve into the back pressure chamber to push the leaf valve with the secondary pressure.

In the damping valve, since the control valve is provided downstream from the back pressure chamber, when the valve opening pressure of the control valve is adjusted by driving force of the solenoid, the secondary pressure led to the back pressure chamber is controlled to be equal to the valve opening pressure of the control valve.

In this way, the secondary pressure introduced into the back pressure chamber acts on the back of the leaf valve, as described above, and pressure acts on the front of the leaf valve from upstream of the port. Therefore, when the force that causes the leaf valve to leave the disk with upstream pressure of the port exceeds the force of pushing the leaf valve against the disk with the secondary pressure, the leaf valve leaves the disk and opens the valve.

That is, the damping valve can adjust the valve opening pressure of the leaf valve in magnitude by controlling the pressure within the back pressure chamber acting on the back of the leaf valve by adjusting the valve opening pressure of the control valve, thereby changing resistance given to the flow of hydraulic oil passing through the port to allow the shock absorber to generate desired damping force.

### CITATION LIST

### Patent Literature

Patent Literature 1: JP 2014-173714 A

### SUMMARY OF INVENTION

The conventional damping valve includes a housing coupled to a shaft portion with a leaf valve attached to the outer circumference, and a tubular spool that is slidably attached to the outer circumference of the housing and abuts on the outer circumference of the back of the leaf valve, and the back pressure chamber is formed with the housing and the spool.

To prevent the spool from separating from the leaf valve, the spool is always pressed toward the leaf valve with the leaf spring with the inner circumference fixed to the shaft portion to which the leaf valve is attached. Therefore, the spool is provided with a flange protruding inward in the inner circumference at the end on the leaf valve side, and the leaf spring presses the spool toward the leaf valve with the outer circumference seated on the flange.

In the damping valve configured in this way, since the spool moves in the axial direction when the leaf valve deflects the outer circumferential side to open the valve, the inertia of the spool affects the responsiveness of the opening and closing operations. However, since the diameter of the spool in the conventional damping valve is large and the flange on which the leaf spring abuts is provided in the inner circumference of the spool, the inertial mass of the spool is large, and the conventional damping valve is difficult to achieve high responsiveness about the opening and closing operations.

Therefore, an object of the present invention is to provide a damping valve that can improve the responsiveness about the opening and closing operations and a shock absorber that can improve the responsiveness of the damping force generation.

To solve the above-described problem, the damping valve of the present invention includes a disk with a port and a valve seat surrounding the port, a leaf valve that opens and closes the port by causing the front side to sit on and leave the valve seat, a tubular housing provided on the back side of the leaf valve, an annular spool that abuts on the back of the leaf valve and is slidably inserted into the inner circumference of the housing to form a back pressure chamber that causes the back pressure to act on the leaf valve inwardly together with the housing, an annular spring support portion that is located on the back side of the leaf valve, faces the inside of the back pressure chamber, and has a smaller outer diameter than the inner diameter of the spool, and an annular leaf spring that is interposed between one end of the spool that is the opposite end of the leaf valve and the spring support portion, and presses the spool in a direction of abutting on the leaf valve.

In the damping valve configured in this way, the spool is disposed in the inner circumference of the housing to allow the spool to have a smaller inner and outer diameter, and the leaf spring pressing the spool is supported by the opposite end of the leaf valve of the spool, eliminating the need to provide a spring seat that supports the leaf spring in the inner circumference of the spool.

### BRIEF DESCRIPTION OF DRAWINGS

FIG. 1 is a longitudinal sectional view illustrating a damping valve according to one embodiment of the present invention.

FIG. 2 is a longitudinal sectional view conceptually illustrating a shock absorber including the damping valve according to one embodiment of the present invention.

FIG. 3 is an enlarged view of a valve portion of the damping valve according to one embodiment of the present invention.

FIG. 4 is a perspective view of a spool in the damping valve according to one embodiment of the present invention.

FIG. 5 is a diagram illustrating characteristics of pressing force of a leaf spring with respect to an amount of movement of the spool of the damping valve according to one embodiment of the present invention.

FIG. 6 is an enlarged view of a solenoid portion of the damping valve according to one embodiment of the present invention.

FIG. 7 is a diagram illustrating characteristics of driving force generated by the solenoid with respect to a current amount applied to the solenoid of the damping valve according to one embodiment of the present invention.

FIG. 8 is a diagram illustrating damping characteristics of the shock absorber to which the damping valve according to one embodiment of the present invention is applied.

### DESCRIPTION OF EMBODIMENTS

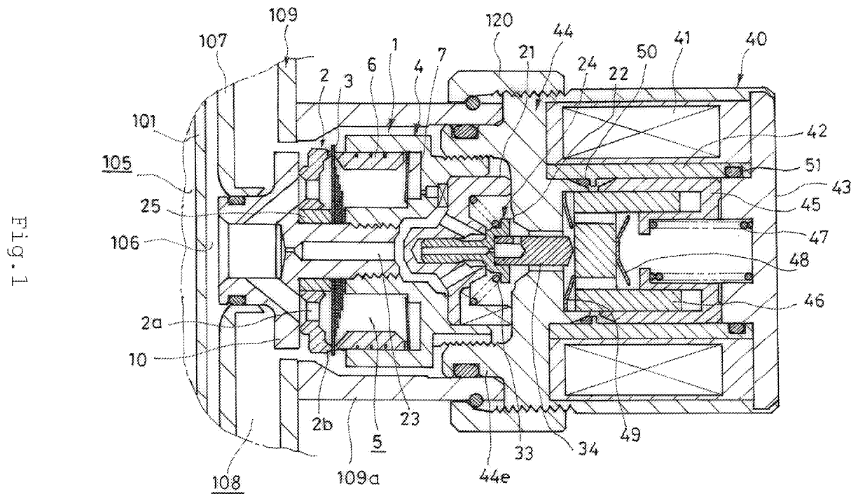

Hereinafter, the present invention will be described on the basis of one embodiment illustrated in the drawings. A damping valve 1 according to one embodiment includes, as illustrated in FIG. 1, a disk 2 with a port 2a and a valve seat 2b surrounding the port 2a, a leaf valve 3 that opens and closes the port 2a by causing the front side to sit on and leave the valve seat 2b, a tubular housing 4 provided on the back side of the leaf valve 3, an annular spool 6 that abuts on the back of the leaf valve 3 and is slidably inserted into the inner circumference of the housing 4 to form a back pressure chamber 5 that causes the back pressure to act on the leaf valve 3 inwardly together with the housing 4, an annular spring support portion 4g that is located on the back side of the leaf valve 3, faces the inside of the back pressure chamber 5, and has a smaller outer diameter than the spool 6, and an annular leaf spring 7 that is interposed between one end of the spool 6 that is the opposite end of the leaf valve and the spring support portion 4g and presses the spool 6 in a direction of abutting on the leaf valve 3.

This damping valve 1 is applied to the shock absorber 100. The shock absorber 100 is configured to generate damping force primarily by giving resistance to liquid passing through the port 2a during expansion and contraction.

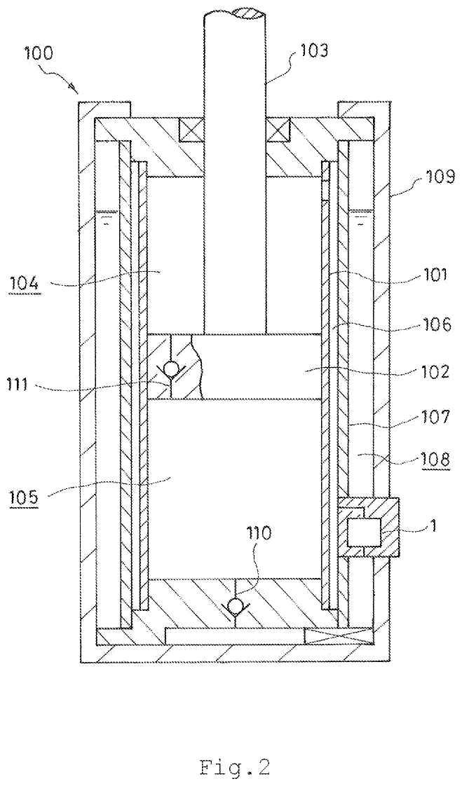

The shock absorber 100 to which the damping valve 1 is applied includes, for example, as illustrated in FIG. 2, a cylinder 101, a piston 102 inserted slidably into the cylinder 101, a rod 103 that is moved and inserted into the cylinder 101 and connected to the piston 102, an extension side chamber 104 and a compression side chamber 105 divided by the piston 102 inserted into the cylinder 101, an intermediate tube 107 covering the outer circumference of the cylinder 101 to form a discharge passage 106 between the intermediate tube 107 and the cylinder 101, and an outer tube 109 covering the outer circumference of the intermediate tube 107 to form a reservoir 108 between the outer tube 109 and the intermediate tube 107. The extension side chamber 104 and the compression side chamber 105 are filled with liquid, and not only liquid but also gas is sealed in the reservoir 108. Note that the shock absorber 100 of the present embodiment uses hydraulic oil as the liquid. However, liquid other than hydraulic oil can be used as long as the liquid can exert damping force by using the damping valve 1.

The shock absorber 100 includes a suction passage 110 that allows only the flow of hydraulic oil from the reservoir 108 to the compression side chamber 105, and a rectifying passage 111 provided in the piston 102 to allow only the flow of hydraulic oil from the compression side chamber 105 to the extension side chamber 104. The discharge passage 106 cause the extension side chamber 104 to communicate with the reservoir 108. The damping valve 1 connects the port 2a to the discharge passage 106 and is provided partway in the discharge passage 106.

Therefore, when this shock absorber 100 performs a compression operation, the piston 102 moves downward in FIG. 2, the compression side chamber 105 is compressed, and the hydraulic oil in the compression side chamber 105 moves to the extension side chamber 104 via the rectifying passage 111. During the compression operation, since the rod 103 enters the cylinder 101, the hydraulic oil becomes excessive for the rod entering volume within the cylinder 101, and the excessive hydraulic oil is pushed out from the cylinder 101 and discharged to the reservoir 108 via the discharge passage 106. The shock absorber 100 gives resistance to the flow of hydraulic oil moving through the discharge passage 106 to the reservoir 108 with the damping valve 1, raises the pressure within the cylinder 101 to exert compression side damping force.

Conversely, when the shock absorber 100 performs an expansion operation, the piston 102 moves upward in FIG. 2, the extension side chamber 104 is compressed, and the hydraulic oil in the extension side chamber 104 moves to the reservoir 108 via the discharge passage 106. During the expansion operation, the piston 102 moves upward, the volume of the compression side chamber 105 expands, and the hydraulic oil corresponding to this expansion is supplied from the reservoir 108 via the suction passage 110. Then, the shock absorber 100 gives resistance to the flow of hydraulic oil moving through the discharge passage 106 to the reservoir 108 with the damping valve 1, raises the pressure within the extension side chamber 104 to exert extension side damping force.

As can be understood from the above description, the shock absorber 100 is set to a uniflow shock absorber in which, when exhibiting expansion and contraction operations, the hydraulic oil is always discharged from the inside of the cylinder 101 to the reservoir 108 via the discharge passage 106, the hydraulic oil circulates through the compression side chamber 105, the extension side chamber 104, and the reservoir 108 in one-way order, and the damping force on both sides of extension and compression is generated by the single damping valve 1.

Subsequently, as described above, the damping valve 1 includes the disk 2 with the port 2a and the valve seat 2b surrounding the port 2a, the leaf valve 3 that opens and closes the port 2a by causing the front side to sit on and leave the valve seat 2b, the tubular housing 4 provided on the back side of the leaf valve 3, the annular spool 6 that abuts on the back of the leaf valve 3 and is slidably inserted into the inner circumference of the housing 4 to form the back pressure chamber 5 that causes the back pressure to act on the leaf valve 3 inwardly together with the housing 4, the annular spring support portion 4g that is located on the back side of the leaf valve 3, faces the inside of the back pressure chamber 5, and has a smaller outer diameter than the spool 6, and the annular leaf spring 7 that is interposed between one end of the spool 6 that is the opposite end of the leaf valve and the spring support portion 4g and presses the spool 6 in a direction of abutting on the leaf valve 3. In addition, in the present embodiment, the damping valve 1 includes a valve holding member 10 fitted in a sleeve 107a provided in the opening of the intermediate tube 107, a pilot passage 23 that is provided inside the valve holding member 10 and the housing 4 to guide upstream pressure of the port 2a to the back pressure chamber 5, a control valve 24 provided in the pilot passage 23, and a solenoid 40 giving driving force to the control valve.

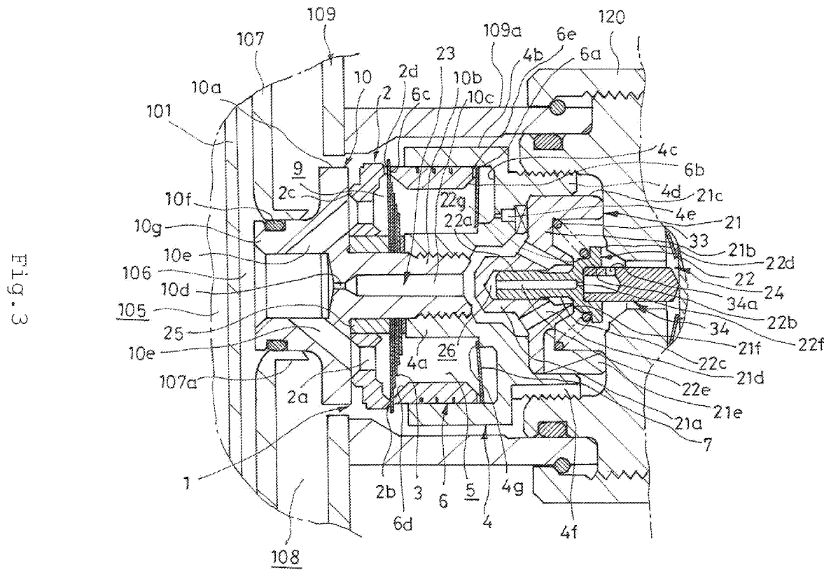

Each part of the damping valve 1 will be described in detail below. The valve holding member 10 includes, as illustrated in FIG. 3, a large-diameter base portion 10a fitted in the sleeve 107a, a shaft portion 10b protruding rightward from the base portion 10a in FIG. 3 and having a screw portion (without symbol) at the right end of the outer circumference in FIG. 3, a hollow portion 10c formed to penetrate the base portion 10a and the shaft portion 10b in the axial direction to form part of the pilot passage 23, an orifice 10d provided partway in the hollow portion 10c, and a plurality of passages 10e penetrating from the left end to the right end of the base portion 10a in FIG. 3.

Each passage 10e penetrates the base portion 10a and leads to the hollow portion 10c as described above, and further communicates with the inside of the extension side chamber 104 via the discharge passage 106 formed by the intermediate tube 107 via the hollow portion 10c. An opening on the right end side of the base portion 10a in the passage 10e in FIG. 3 communicates with the reservoir 108. That is, the shock absorber 100 is configured to discharge the hydraulic oil from the extension side chamber 104 via the discharge passage 106 and the passage 10e to the reservoir 108 when expanding or contracting. The extension side chamber 104 is upstream of the passage 10e. An opening on the left end side of the hollow portion 10c in FIG. 3 also communicates with the inside of the extension side chamber 104 via the discharge passage 106, in a similar manner to the passage 10e.

Note that a small-diameter portion 10g formed by reducing the diameter of the left side of the base portion 10a of the valve holding member 10 in FIG. 3 fits in the sleeve 107a. A seal ring 10f is attached to the outer circumference of the small-diameter portion 10g to seal with the sleeve 107a, thereby preventing the discharge passage 106 from leading to the reservoir 108 via the outer circumference of the base portion 10a.

Subsequently, the disk 2, which opens and closes the passage 10e by leaving and sitting on the base portion 10a, is stacked at the right end of the base portion 10a of the valve holding member 10 in FIG. 3. The annular disk 2 includes: the plurality of ports 2a penetrating the wall thickness in the axial direction; and the annular valve seat 2b provided on the back side on the opposite side of the valve holding member, surrounding the outer circumference of the ports 2a, and protruding to the back side. Furthermore, the disk 2 includes an annular protrusion 2c protruding from the end facing the base portion 10a of the valve holding member 10 to the base portion 10a side. The annular protrusion 2c faces the outer circumferential side of the passage 10e in the base portion 10a. When the disk 2 abuts on the base portion 10a, the annular protrusion 2c sits on the outer circumferential side of the passage 10e of the base portion 10a. Therefore, when the disk 2 abuts on the base portion 10a, the disk 2 blocks an exit end of the passage 10e. The port 2a is designed to give resistance to the flow of hydraulic oil passing through. As will be described later in detail, when the hydraulic oil passes through the passage 10e and moves to the back side of the disk 2 through the port 2a, a difference in pressure develops between the valve holding member side, which is the front side of the disk 2, and the back side. Note that in the damping valve 1 of the present embodiment, the annular protrusion 2c is provided in the disk 2, but the base portion 10a of the valve holding member 10 may be provided with a valve seat surrounding the outer circumference of the passage 10e.

The disk 2 is slidably attached to the outer circumference of an annular spacer 25 attached to the outer circumference of the shaft portion 10b of the valve holding member 10. The spacer 25 has an axial thickness thicker than the axial thickness of the inner circumference of the disk 2. The disk 2 can move along the outer circumference of the spacer 25 in both right-and-left directions, which are the axial direction in FIG. 3. Therefore, the disk 2 is assembled in a floating state with respect to the valve holding member 10, can leave and sit on the base portion 10a by approaching and leaving the valve holding member 10, and releases the passage 10e when leaving the base portion 10a. In addition, the valve seat 2b is provided with a notch orifice 2d. Instead of the notch orifice 2d, the orifice may be provided in the valve holding member 10 or the annular protrusion 2c of the disk 2.

Furthermore, the leaf valve 3 is stacked on the back side of the disk 2. The leaf valve 3 is a stacked leaf valve configured by stacking a plurality of annular plates. The inner circumference is assembled to the shaft portion 10b and sandwiched between the spacer 25 and the housing 4 screwed to the shaft portion 10b. Therefore, the leaf valve 3 can leave and sit on the valve seat 2b of the disk 2 with deflection on the outer circumferential side allowed. The outer diameter of the annular plate in the leaf valve 3 decreases in stages as stacked to the back side.

The inner circumference of the leaf valve 3 is stacked on the spacer 25, and the outer circumference sits on the valve seat 2b protruding from the back of the disk 2 to the leaf valve 3 side. Therefore, there is a space between the leaf valve 3 and the disk 2, and an intermediate chamber 9 is formed in this space. Note that the intermediate chamber 9 communicates with the passage 10e via the port 2a. Then, when the leaf valve 3 receives pressure acting in the intermediate chamber 9 via the port 2a, deflects, and leaves the valve seat 2b, an annular gap is formed between the leaf valve 3 and the disk 2, and the hydraulic oil that has passed the passage 10e and the port 2a can pass between the leaf valve 3 and the disk 2 and move to the reservoir 108. That is, even if the disk 2 is seated on the base portion 10a, if the leaf valve 3 deflects and leaves the valve seat 2b, the port 2a is opened and the hydraulic oil can move from the extension side chamber 104 to the reservoir 108.

Furthermore, when the leaf valve 3 deflects and the disk 2 is pushed up by the pressure received from the passage 10e, the disk 2 as a whole slides on the spacer 25 and leaves the base portion 10a. In this case, the hydraulic oil that has passed through the passage 10e is discharged to the reservoir 108 via an annular gap formed between the disk 2 and the base portion 10a. Note that the leaf valve 3 is configured as a stacked leaf valve in which a plurality of annular plates is stacked, and the number of annular plates is arbitrary.

The housing 4 is screwed to the right end in FIG. 1, which is the tip of the shaft portion 10b. Then, the spacer 25 assembled to the shaft portion 10b and the leaf valve 3 are sandwiched and fixed between the base portion 10a of the valve holding member 10 and the housing 4. Note that as described above, the disk 2 attached to the outer circumference of the spacer 25 is in a floating state fixed to the outer circumference of the spacer 25, and can move in the axial direction.

The housing 4 includes, as illustrated in FIG. 3, an inner tube 4a having a screw portion (without symbol) on the inner circumference and screwed to the shaft portion 10b of the valve holding member 10, an outer tube 4b facing the inner tube 4a with an annular gap, a flange-shaped bottom portion 4c protruding radially from the right end of the outer circumference of the inner tube 4a in FIG. 3 and connected to the right end of the outer tube 4b in FIG. 3, a tubular socket 4d that rises from the opposite side of the inner tube of the bottom portion 4c and has a screw portion (without symbol) on the outer circumference, a hole 4e that penetrates the bottom portion 4c and causes the annular gap between the inner tube 4a and the outer tube 4b to communicate with the inside of the socket 4d, and a notch groove 4f provided along the axial direction in the outer circumference of the socket 4d.

When screwed to the shaft portion 10b of the valve holding member 10, the inner tube 4a of the housing 4 cooperates with the base portion 10a of the valve holding member 10 to sandwich the spacer 25 and the leaf valve 3. The outer circumference of the inner tube 4a in the housing 4 has a large outer diameter at the right end in FIG. 3 that is the base end to form a step portion. The spring support portion 4g, which is an annular surface facing the back of the leaf valve 3, is provided at the step portion. The spring support portion 4g functions as a spring seat supporting the inner circumference of the leaf spring 7. The inside of the housing 4 is connected to the hollow portion 10c of the valve holding member 10, and communicates with the inside of the extension side chamber 104, which is upstream of the passage 10e, via the orifice 10d.

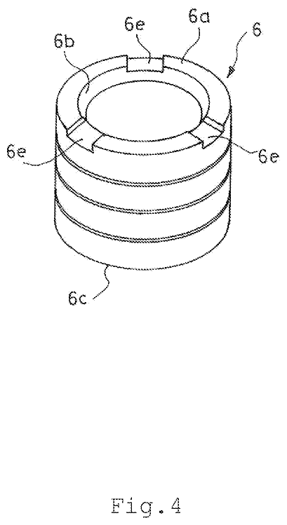

As illustrated in FIG. 3, the spool 6 is slidably inserted into the inner circumference of the outer tube 4b. The annular spool 6 includes a first-end outer circumferential portion 6a that is the outer circumferential portion of the first end on the opposite leaf valve side (right end in FIG. 3), a tapered portion 6b inclined to the second-end side inside the first-end outer circumferential portion 6a, a second-end outer circumferential portion 6c that is the outer circumferential portion of the second end that is the leaf valve side end (left end in FIG. 3), and a tapered portion 6d inclined to the first end side inside the second-end outer circumferential portion 6c. The spool 6 includes a plurality of grooves 6e radially penetrating the first-end outer circumferential portion 6a, as illustrated in FIG. 4. Note that in the damping valve 1 of the present embodiment, three grooves 6e are provided in the circumferential direction of the spool 6 at equal intervals.

The spool 6 can move in the axial direction with respect to the housing 4, causes the second-end outer circumferential portion 6c to abut on the circumferential portion on the back of the leaf valve 3, and cooperates with the housing 4 to form the back pressure chamber 5. The back pressure chamber 5 communicates with the inside of the socket 4d via the hole 4e provided in the bottom portion 4c of the housing 4. As described above, since the inside of the housing 4 communicates with the inside of the extension side chamber 104, the hydraulic oil discharged from the extension side chamber 104 is led to the back pressure chamber 5 via the orifice 10d and hole 4e. In this way, the pressure upstream of the passage 10e is reduced by the orifice 10d and introduced into the back pressure chamber 5.

Since the spool 6 includes the tapered portion 6d inside the second-end outer circumferential portion 6c of the spool 6 on which the outer circumference of the leaf valve 3 abuts, the spool 6 does not interfere even if the leaf valve 3 is a stacked leaf valve with the outer diameter decreasing in stages toward the back side. The design about the number of annular plates and the outer diameter of the leaf valve 3 can be changed arbitrarily, and providing the tapered portion 6d on the second-end side, which is the leaf valve side end of the spool 6, allows higher degree of flexibility in the selection of the number of annular plates and the outer diameter of the leaf valve 3.

In the damping valve 1 of the present embodiment, the leaf spring 7 is an annular disk spring. The inner circumference on the opposite side of the leaf valve is supported by the spring support portion 4g provided in the housing 4, and the outer circumference on the leaf valve side is supported by the first-end outer circumferential portion 6a of the spool 6. The outer diameter of the spring support portion 4g is smaller than the inner diameter of the spool 6. In a state where the leaf valve 3 sits on the valve seat 2b of the disk 2, the disk 2 sits on the base portion 10a of the valve holding member 10, and the spool 6 abuts on the leaf valve 3, the surface of the spring support portion 4g supporting the leaf spring 7 is disposed on the leaf valve side of the surface of the first-end outer circumferential portion 6a of the spool 6 supporting the leaf spring 7 in the axial direction of the spool 6. That is, in FIG. 3, the spring support portion 4g of the housing 4 is disposed leftward of the first-end outer circumferential portion 6a of the spool 6.

Therefore, the leaf spring 7 is interposed between the spool 6 and the spring support portion 4g in a deflected state with an initial deflection given, and always presses the spool 6 in a direction to abut on the leaf valve 3. The initial deflection amount of the leaf spring 7 can be set by setting the axial length of the spool 6 and the axial position of the spring support portion 4g. Since the leaf spring 7 needs to always press the spool 6 to prevent the spool from separating from the leaf valve 3, it is required at least to set the spring support portion 4g of the housing 4 closer to the leaf valve 3 in the axial direction than the first-end outer circumferential portion 6a of the spool 6. However, since the pressing force of the leaf spring 7 affects the valve opening pressure of the damping valve 1, the pressing force by which the leaf spring 7 presses the spool 6 is preferably as small as possible, and therefore it is desirable to reduce the initial deflection amount of the leaf spring 7.

Only the inner circumference on the opposite side of the leaf valve of the leaf spring 7 abuts on the spring support portion 4g facing the back of the leaf valve 3, and the inner circumference of the leaf spring 7 is not fixedly supported by the housing 4. Therefore, when the spool 6 moves in the axial direction separating from the disk 2, the pressing force given by the leaf spring 7 that is not fixedly supported to the spool 6 is smaller than the pressing force of the leaf spring when the inner circumference is fixed. Therefore, when the structure in which the leaf spring 7 is supported by the spring support portion 4g in this way is adopted, the apparent spring constant of the leaf spring 7 will be lower, and therefore the increase in the pressing force given by the leaf spring 7 to the spool 6 when the spool 6 moves in the direction separating from the disk 2 can be suppressed.

Furthermore, the tapered portion 6b provided inside the first-end outer circumferential portion 6a of the spool 6 allows the inner diameter of the first-end outer circumferential portion 6a to be large. The support diameter on the outer circumferential side of the leaf spring 7 is determined by the inner diameter of the first-end outer circumferential portion 6a of the spool 6. As the support diameter increases, the deflection amount of the leaf spring 7 caused by the movement of the spool 6 can be reduced more. Therefore, if the tapered portion 6b is provided inside the first-end outer circumferential portion 6a of the spool 6, the apparent spring constant of the leaf spring 7 can be lowered, and therefore the increase in the pressing force given by the leaf spring 7 to the spool 6 when the spool 6 moves in the direction separating from the disk 2 can be suppressed.

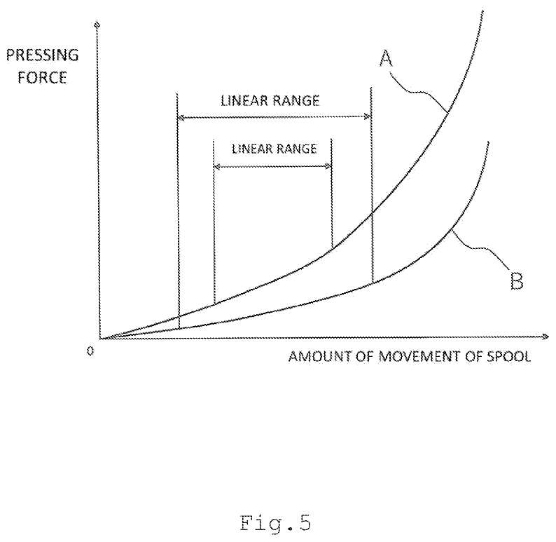

Note that the first-end outer circumferential portion 6a of the spool 6 is provided with the groove 6e. Even if the leaf spring 7 does not include any holes or grooves, the chamber on the leftward leaf valve side of the leaf spring 7 in FIG. 3 communicates with the chamber on the rightward opposite side of the leaf valve in FIG. 3 by the groove 6e, and therefore the leaf spring 7 does not divide the back pressure chamber 5. The groove 6e is provided to ensure a channel area that is large enough to prevent differential pressure between the chamber on the leaf valve side and the chamber on the opposite side of the leaf valve of the leaf spring 7 in the back pressure chamber 5. As illustrated in FIG. 5, the characteristics of magnitude of the pressing force the leaf spring 7 gives to the spool 6 for the amount of movement of the spool 6 can be changed by setting the circumferential width of the groove 6e. When the width of the groove 6e is narrowed, as illustrated by the characteristic line A in FIG. 5, the apparent spring constant of the leaf spring 7 shows a tendency to become larger, and the linear range appearing partway in the characteristic line A (range where the pressing force of the leaf spring 7 is proportional to the amount of movement of the spool 6) becomes narrow. When the width of the groove 6e is widened, as illustrated by the characteristic line B in FIG. 5, the apparent spring constant of the leaf spring 7 shows a tendency to become smaller, and the linear range appearing partway in the characteristic line B (range where the pressing force of the leaf spring 7 is proportional to the amount of movement of the spool 6) becomes wide. Since the channel area of the groove 6e needs to be ensured as described above, when the width of the groove 6e is to be narrowed, the number of grooves 6e to install may be increased, and when the width of the groove 6e is to be widened, the number of grooves 6e to install may be decreased. Therefore, according to the required specification for the damping valve 1, it is required at least to determine the characteristics of the pressing force to be given by the leaf spring 7 to the spool 6 and set the number of grooves 6e to install and the width as appropriate. Note that instead of providing the groove 6e in the spool 6 to avoid fragmentation of the back pressure chamber 5, the leaf spring 7 may be a perforated leaf spring.

As described above, since the hydraulic oil discharged from the extension side chamber 104 is led to the back pressure chamber 5 via the orifice 10d and hole 4e, the pressing force that pushes the leaf valve 3 toward the disk 2 acts on the back of the leaf valve 3 by the internal pressure of the back pressure chamber 5, other than the pressing force by the leaf spring 7 that presses the spool 6. That is, when the shock absorber 100 performs expansion and contraction operations, the pressure in the extension side chamber 104 acts on the disk 2 from the front side via the passage 10e, and the internal pressure of the back pressure chamber 5 and the pressing force by the leaf spring 7 acts from the back side via the leaf valve 3.

Note that the force of the value obtained by multiplying the back side pressure receiving area obtained by subtracting the area of a circle whose diameter is the outer diameter of the smallest-diameter annular plate stacked in the top row of the leaf valve 3 from the area of a circle whose diameter is the outer diameter of the spool 6 by the pressure of the back pressure chamber 5 acts on the leaf valve 3 to be pushed against the disk 2, and the force of the value obtained by multiplying the front side pressure receiving area obtained by subtracting the area of a circle whose diameter is the outer diameter of the spacer 25 from the area of a circle whose diameter is the inner diameter of the valve seat 2b by the pressure of the intermediate chamber 9 acts on the leaf valve 3 in a direction separating from the disk 2. Therefore, the ratio of the back side pressure receiving area to the front side pressure receiving area of the leaf valve 3 determines the pressure intensification ratio, which is the ratio of the valve opening pressure of the leaf valve 3 to the pressure within the back pressure chamber 5.

When the pressure within the intermediate chamber 9 is increased by the pressure within the extension side chamber 104 and the force to deflect the outer circumference of the leaf valve 3 rightward in FIG. 3 overcomes the internal pressure of the back pressure chamber 5 and the pressing force by the leaf spring 7, the leaf valve 3 deflects and leaves the valve seat 2b, forming a gap between the leaf valve 3 and the disk 2, and opening the passage 10e. In this embodiment, the inner diameter of the valve seat 2b is larger than the inner diameter of the annular protrusion 2c, and there is a difference between the pressure receiving area where the disk 2 receives pressure on the passage 10e side and the pressure receiving area where the disk 2 receives pressure on the intermediate chamber 9 side. If the differential pressure generated by the port 2a does not reach the valve opening pressure that causes the disk 2 to leave the base portion 10a of the valve holding member 10, the disk 2 will remain seated on the base portion 10a. Meanwhile, when the leaf valve 3 deflects to be in a valve open state and the differential pressure generated by the port 2a reaches the valve opening pressure that causes the disk 2 to leave the base portion 10a, the disk 2 will also leave the base portion 10a and open the passage 10e. That is, the pressure intensification ratio in the leaf valve 3 is set smaller than the pressure intensification ratio in the disk 2, which is the ratio of the valve opening pressure of the disk 2 to the pressure of the intermediate chamber 9, and the pressure in the extension side chamber 104 when the leaf valve 3 opens is lower than the pressure in the extension side chamber 104 when the disk 2 opens. That is, the valve opening pressure of the leaf valve 3 is set to be lower than the valve opening pressure of the disk 2.

Subsequently, a tubular valve seat member 21 is housed inside the right end of the socket 4d and the inner tube 4a in the housing 4 in FIG. 3. The valve seat member 21 includes a small-diameter cylindrical portion 21a having a tubular shape with a bottom, a flange portion 21b protruding outward from the outer circumference at the end that is the right end of the small-diameter cylindrical portion 21a in FIG. 3, a large-diameter cylindrical portion 21c extending from the outer circumference of the flange portion 21b toward the opposite side of the small-diameter cylindrical portion 21a, a through-hole 21d opening diagonally from the side of the small-diameter cylindrical portion 21a to the inner circumference of the flange portion 21b, a notch 21e radially penetrating the large-diameter cylindrical portion 21c and causing the inside and outside of the large-diameter cylindrical portion 21c to communicate with each other, and an annular control valve seat 21f protruding from the inner circumference at the right end of the flange portion 21b in the axial direction in FIG. 3.

The valve seat member 21 is housed in the housing 4 with the large-diameter cylindrical portion 21c fitted in the socket 4d of the housing 4. Note that the inside of the valve seat member 21 communicates with the reservoir 108 via the notch 21e and the notch groove 4f provided in the socket 4d. The outer diameter of the small-diameter cylindrical portion 21a is smaller than the inner diameter of the inner tube 4a of the housing 4. The inside of the valve seat member 21 communicates with the extension side chamber 104 via the through-hole 21d, the hollow portion 10c of the valve holding member 10, and the orifice 10d.

Subsequently, a control valve body 22 is slidably inserted into the small-diameter cylindrical portion 21a of the valve seat member 21. In detail, the control valve body 22 includes a small-diameter portion 22a on the left end side in FIG. 3 that is the valve seat member side that is slidably inserted into the small-diameter cylindrical portion 21a, a large-diameter portion 22b on the right end side in FIG. 3 that is the opposite side of the valve seat member, an annular recess 22c provided between the small-diameter portion 22a and the large-diameter portion 22b, a flange-shaped spring seat 22d provided on the outer circumference at the opposite valve seat member side end, a communication passage 22e penetrating from the tip to the rear end of the control valve body 22, and an orifice 22f provided partway in the communication passage 22e.

The recess 22c of the control valve body 22 always faces the through-hole 21d such that the control valve body 22 does not block the through-hole 21d when the control valve body 22 moves with respect to the valve seat member 21 within an allowable range in the axial direction.

In the control valve body 22, as described above, the outer diameter on the opposite side of the valve seat member is larger with the recess 22c as a boundary. An annular valve portion 22g is provided on the left end of the large-diameter portion 22b in FIG. 3 to face the control valve seat 21f of the valve seat member 21. The movement of the control valve body 22 in the axial direction with respect to the valve seat member 21 causes the valve portion 22g to leave and sit on the control valve seat 21f.

Furthermore, a coil spring 33 that presses the control valve body 22 to the opposite side of the valve seat member is interposed between the spring seat 22d and the flange portion 21b. The control valve body 22 is always pressed to the opposite side of the valve seat member by the coil spring 33. In this way, while the control valve body 22 is pressed by the coil spring 33 in a direction separating from the valve seat member 21, the control valve body receives driving force from the solenoid 40 in a direction of sitting on the valve seat member 21.

In this way, the control valve body 22, the valve seat member 21, the coil spring 33, and the solenoid 40 constitute the control valve 24. When the valve portion 22g sits on the control valve seat 21f, the control valve 24 closes. The control valve 24 breaks the communication between the hollow portion 10c of the valve holding member 10 and the inside of the valve seat member 21 in the valve closed state, and allows the hollow portion 10c to communicate with the inside of the valve seat member 21 in the valve open state. Therefore, when the control valve 24 opens, the extension side chamber 104 communicates with the reservoir 108 via the hollow portion 10c, the orifice 10d, the through-hole 21d, the inside of the valve seat member 21, the notch 21e, and the notch groove 4f. In this way, in the present embodiment, the hollow portion 10c, the orifice 10d, the through-hole 21d, the inside of the valve seat member 21, the notch 21e, and the notch groove 4f form the pilot passage 23. The downstream portion from the orifice 10d in the pilot passage 23 leads to the back pressure chamber 5 via the hole 4e of the housing 4, and the pressure downstream of the orifice 10d of the pilot passage 23 can be adjusted by controlling the valve opening pressure of the control valve 24.

The valve opening pressure of the control valve 24 is controlled by the solenoid 40 described later, and the pressure in the back pressure chamber 5 can be adjusted by the current amount to be applied to the solenoid 40. Since the pressure in the back pressure chamber 5 acts on the back of the leaf valve 3, the damping valve 1 of the present embodiment can adjust the valve opening pressure of the leaf valve 3 by adjusting the current amount to be applied to the solenoid 40, whereby the damping force generated by the shock absorber 100 can be changed in magnitude.

Note that, in this case, the control valve body 22 is pressed in a direction away from the valve seat member 21 by using the coil spring 33, but an elastic material can be used that can exert the pressing force, besides the coil spring 33. Furthermore, a plunger 34 is fitted in the large-diameter portion 22b of the control valve body 22.

When the control valve body 22 is inserted into the small-diameter cylindrical portion 21a of the valve seat member 21, the control valve body forms a space 26 within the small-diameter cylindrical portion 21a on the tip side of the through-hole 21d. The space 26 communicates with the outside of the control valve 24 via the communication passage 22e provided in the control valve body 22, the orifice 22f, and a through hole 34a provided in the plunger 34. With this configuration, when the control valve body 22 moves in the axial direction, which is the left-right direction with respect to the valve seat member 21 in FIG. 1, the space 26 functions as a dashpot to inhibit the steep displacement of the control valve body 22, and can inhibit oscillatory movement of the control valve body 22.

Each part in the damping valve 1 configured in this way is housed in a sleeve 109a attached to an opening provided in the outer tube 109 of the shock absorber 100, and is fixed to the shock absorber 100 by screwing the solenoid 40 to a nut 120 rotatably attached to the sleeve 109a.

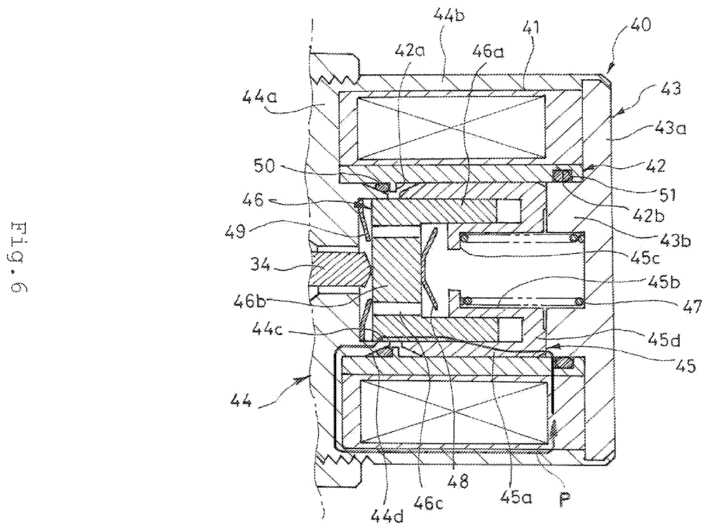

The solenoid 40 includes, as illustrated in FIG. 6, a tubular resin-molded the coil 41, a filler ring 42 including a tubular non-magnetic material fitted in the inner circumference of the coil 41, a first fixed iron core 43 that abuts on the right end of the coil 41 in FIG. 6 and is fitted in the inner circumference at the right end in FIG. 6 of the filler ring 42, a second fixed iron core 44 that abuts on the left end of the coil 41 in FIG. 6 and is fitted in the inner circumference at the left end of the filler ring 42 in FIG. 6 with a gap from the first fixed iron core 43, a first movable iron core 45 and a second movable iron core 46 disposed between the first fixed iron core 43 and the second fixed iron core 44 to allow vertical movement, a spring 47 that presses the first movable iron core 45 leftward to the control valve side in FIG. 6, a disk spring 48 that restricts the amount of downward movement of the first movable iron core 45 with respect to the second movable iron core 46, and a disk spring 49 that restricts the amount of downward movement of the second movable iron core 46.

The coil 41 is resin-molded in a tubular shape, and disposed in the outer circumference of the first movable iron core 45 and the second movable iron core 46. A tubular filler ring 42 including a non-magnetic material is fitted in the inner circumference of the coil 41. The filler ring 42 includes an annular flange 42a protruding inward from the inner circumference on the left-end side in FIG. 6 and an annular groove 42b provided on the inner circumference at the right end in FIG. 6.

The first fixed iron core 43 includes a magnetic material, and includes a disk-shaped base 43a that abuts on the right end of the resin-molded coil 41 in FIG. 6, and a tubular fitting portion 43b that rises from the base 43a and is fitted in the inner circumference of the filler ring 42.

The second fixed iron core 44 includes a magnetic material, and includes an annular base 44a that abuts on the left end of the resin-molded coil 41 in FIG. 6, a tubular case portion 44b that rises from the outer circumference of the base 44a, and a tubular fitting portion 44c that rises from the inner circumferential side of the base 44a and is fitted in the inner circumference of the filler ring 42.

The coil 41 and the filler ring 42 fitted in the inner circumference of the coil 41 are housed in the inner circumference of the case portion 44b. The first fixed iron core 43 is housed in the inner circumference on the right end side of the case portion 44b in FIG. 6. By caulking the right end of the case portion 44b in FIG. 6 from the outer circumference, the first fixed iron core 43 is gripped by and fixed to the case portion 44b. When the first fixed iron core 43 is fixed to the case portion 44b, the coil 41 and the filler ring 42 are sandwiched between the base 43a of the first fixed iron core 43 and the base 44a of the second fixed iron core 44, the fitting portions 43b and 44c are fitted in the inner circumference of the filler ring 42, and the coil 41 is fitted in the case portion 44b. Therefore, the coil 41 and the filler ring 42 are housed between the first fixed iron core 43 and the second fixed iron core 44 while axially and radially constrained.

A tapered chamfer 44d is provided on the outer circumference at the right end in FIG. 6 that is the tip of the fitting portion 44c of the second fixed iron core 44, and an annular gap is formed between the chamfer and the filler ring 42. A seal ring 50 is housed in the annular gap. The seal ring 50 adheres to the flange 42a provided in the inner circumference of the filler ring 42 and the chamfer 44d of the fitting portion 44c to seal between the second fixed iron core 44 and the filler ring 42. Furthermore, a seal ring 51 that adheres to the outer circumference of the fitting portion 43b of the first fixed iron core 43 is attached to the inside of the annular groove 42b provided on the inner circumference at the right end of the filler ring 42 in FIG. 6. The seal ring 51 seals between the first fixed iron core 43 and the filler ring 42.

The first movable iron core 45 is slidably inserted into the inner circumference of the filler ring 42 and between the fitting portion 43b of the first fixed iron core 43 and the fitting portion 44c of the second fixed iron core 44.

A connecting tube 44e that protrudes leftward and screws into the outer circumference of the socket 4d of the housing 4 in the damping valve 1 is provided at the left end of the base 44a of the second fixed iron core 44 in FIG. 1.

The first movable iron core 45 includes a magnetic material, and includes a sliding contact tube 45a that slides and contacts the inner circumference of the filler ring 42, a tubular spring support tube 45b disposed inside the sliding contact tube 45a and including an annular spring seat 45c protruding toward the inner circumference, and an annular portion 45d connecting the sliding contact tube 45a and the end of the spring support tube 45b in FIG. 6. The axial length of the sliding contact tube 45a of the first movable iron core 45 is shorter than the axial distance between the fitting portion 43b of the first fixed iron core 43 and the fitting portion 44c of the second fixed iron core 44. Therefore, the first movable iron core 45 can be displaced in the axial direction while the movement is guided by the filler ring 42 between the first fixed iron core 43 and the second fixed iron core 44. In the first movable iron core 45, the annular portion 45d faces the left end of the fitting portion 43b of the first fixed iron core 43 in FIG. 6.

The spring 47 is interposed between the spring seat 45c provided in the inner circumference of the spring support tube 45b and the base 43a of the first fixed iron core 43 to always press the first movable iron core 45 in an axial direction of separating from the first fixed iron core 43. The first end of the spring 47 is inserted into the inner circumference of the fitting portion 43b, and the second end is inserted into the spring support tube 45b, and prevents radial displacement of the spring 47.

The second movable iron core 46 is tubular with a bottom, includes a magnetic material, includes a tubular portion 46a and a bottom portion 46b closing the left end of the tubular portion 46a in FIG. 6, and causes the outer circumference of the tubular portion 46a to slidably contact the inner circumference of the sliding contact tube 45a of the first movable iron core 45. Note that the inner diameter of the tubular portion 46a is larger than the outer diameter of the spring support tube 45b of the first movable iron core 45. Therefore, the second movable iron core 46 is guided to move by the sliding contact tube 45a of the first movable iron core 45 that is in sliding contact with the tubular portion 46a, and can relatively move in the axial direction with respect to the first movable iron core 45. Since the first movable iron core 45 causes the outer circumference of the sliding contact tube 45a to slide and contact the filler ring 42, both the first movable iron core 45 and the second movable iron core 46 can move in the axial direction without deviating from the axis of the filler ring 42. Note that the outer circumference of the bottom portion 46b of the second movable iron core 46 is always in contact with the inner circumference of the fitting portion 44c of the second fixed iron core 44.

Since an annular gap is formed between the tubular portion 46a and the spring support tube 45b, the space surrounded by the tubular portion 46a of the second movable iron core 46, the sliding contact tube 45a of the first movable iron core 45, the spring support tube 45b, and the annular portion 45d is not sealed. The bottom portion 46b of the second movable iron core 46 is provided with a communication hole 46c that causes the inside and outside of the second movable iron core 46 to communicate with each other, and the inside of the second movable iron core 46 that communicates with the inside of the spring support tube 45b is also not sealed.

Therefore, the second movable iron core 46 can smoothly move with respect to the first movable iron core 45 in the axial direction, and the first movable iron core 45 can also move smoothly with respect to the filler ring 42 and the second movable iron core 46 in the axial direction.

The spring 47 presses the first movable iron core 45 to the second fixed iron core side. When the first movable iron core 45 and the second movable iron core 46 approach in the axial direction and a disk spring 48 is compressed, the disk spring 48 exerts resilient force to regulate further approach between the first movable iron core 45 and the second fixed iron core 44. When the second movable iron core 46 approaches the second fixed iron core 44 in the axial direction and a disk spring 49 is compressed, the disk spring 49 exerts resilient force to regulate further approach of the second movable iron core 46 to the second fixed iron core 44. Note that instead of the disk springs 48 and 49, an elastic body such as a wave washer or rubber may be provided. A member other than the elastic body may be provided if it is possible to regulate the approach between the first movable iron core 45 and the second movable iron core 46, and the approach between the second movable iron core 46 and the second fixed iron core 44.

The first fixed iron core 43, the second fixed iron core 44, the first movable iron core 45, and the second movable iron core 46 each include a magnetic material, and form a magnetic path P in the solenoid 40. Therefore, when a current passes through the coil 41, the magnetic field generated by the coil 41 goes through the first fixed iron core 43, the second fixed iron core 44, the first movable iron core 45, and the second movable iron core 46, and returns to the coil 41. Therefore, when a current passes through the coil 41, the first movable iron core 45 is attracted to the first fixed iron core 43 disposed on the right side in FIG. 6, and the second movable iron core 46 is attracted to the second fixed iron core 44 disposed on the left side in FIG. 6. That is, when a current passes through the coil 41 in the solenoid 40, the first movable iron core 45 and the second movable iron core 46 are attracted in a direction separating from each other in the axial direction.

After the solenoid 40 configured in this way is assembled to the damping valve 1 by screwing the housing 4 to the second fixed iron core 44, the screw portion (without symbol) provided in the outer circumference at the left end in FIG. 6 of the second fixed iron core 44 is screwed to the nut 120 attached to the sleeve 109a of the outer tube 109 of the shock absorber 100, and is attached to the shock absorber 100. When the second fixed iron core 44 is attached in this way, since all components of the solenoid 40 are housed in the second fixed iron core 44, the solenoid 40 can be attached to the shock absorber 100.

When the solenoid 40 is attached to the shock absorber 100 in this way, the bottom portion 46b of the second movable iron core 46 abuts on the plunger 34 attached to the rear end of the control valve body 22 in the control valve 24. Therefore, the driving force generated by the solenoid 40 is transmitted to the control valve body 22 via the plunger 34. While the control valve body 22 is pressed by the coil spring 33 in the valve opening direction, the control valve body receives the driving force of the solenoid 40 in the valve closing direction. Therefore, when the driving force of the solenoid 40 is adjusted, it is possible to adjust the pressure when the control valve body 22 separates from the valve seat member 21 by the pressure received from the pilot passage 23, that is, the valve opening pressure of the control valve 24. Since the pressure upstream of the control valve 24 of the pilot passage 23 and downstream of the orifice 10d is equal to the valve opening pressure of the control valve 24, the pressure of the back pressure chamber 5 is also equal to the valve opening pressure of the control valve 24. Therefore, by adjusting the driving force of the solenoid 40, the pressure within the back pressure chamber 5 can be controlled.

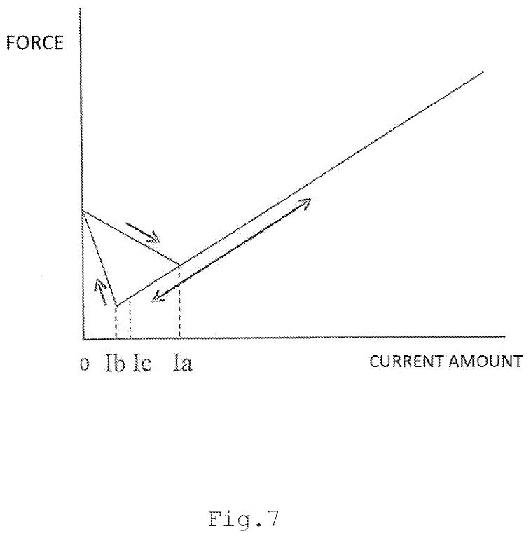

Subsequently, FIG. 7 illustrates the relationship between the current amount supplied to the solenoid 40 and the force applied by the solenoid 40 to the control valve body 22 in the control valve 24. In FIG. 7, the current amount Ia is the minimum current amount required to adsorb the first movable iron core 45 separated from the first fixed iron core 43 to the first fixed iron core 43, and the current amount Ib is the minimum current amount required to maintain the adsorption state of the first fixed iron core 43 and the first movable iron core 45 after the first movable iron core 45 is adsorbed to the first fixed iron core 43. Note that the current amount Ic will be described later. Note that each figure in which the solenoid 40 is illustrated illustrates a state in which a current is supplied to the coil 41 and the first movable iron core 45 is adsorbed to the first fixed iron core 43.

To begin with, when the current amount supplied to the coil 41 is zero, that is, when no current passes through the solenoid 40, the first movable iron core 45 is pushed leftward in FIG. 6 by the pressing force of the spring 47 and hits the second movable iron core 46 via the disk spring 48, and the second movable iron core 46 is pushed leftward together with the control valve body 22. In this way, when no current passes through the solenoid 40, the control valve body 22 receives leftward force by the spring 47 via the second movable iron core 46, the disk spring 48, and the first movable iron core 45. That is, when no current passes through the solenoid 40, the solenoid 40 applies leftward force caused by the pressing force of the spring 47 to the control valve body 22.

Next, when the current amount supplied to the solenoid 40 is increased, the rightward force in FIG. 6 that attracts the first movable iron core 45 to the first fixed iron core 43 increases, and the leftward force in FIG. 6 that attracts the second movable iron core 46 to the second fixed iron core 44 also increases. In such a case, in the region where the current amount supplied to the solenoid 40 is less than the current amount Ia, the pressing force of the spring 47 is transmitted to the control valve body 22, but part of the force of the spring 47 that presses the first movable iron core 45 rightward is offset by the force that attracts the first movable iron core 45 leftward (first fixed iron core 43 side). Therefore, in the region where the current amount is less than the current amount Ia, the leftward force applied by the solenoid 40 to the control valve body 22 decreases as the current amount supplied to the solenoid 40 increases.

Meanwhile, in a case where the current amount supplied to the solenoid 40 increases, in the region where the current amount is the current amount Ia or more, the first movable iron core 45 is attracted and adsorbed by the first fixed iron core 43 against the pressing force of the spring 47. In such a state, the pressing force of the spring 47 is not transmitted to the second movable iron core 46, and only the force that attracts the second movable iron core 46 to the second fixed iron core 44 acts in the direction of pushing down the control valve body 22. Since the leftward force in FIG. 6 that attracts the second movable iron core 46 increases in proportion to the current amount supplied to the solenoid 40, in the region where the current amount supplied to the solenoid 40 is the current amount Ia or more, as the current amount supplied to the solenoid 40 increases, the leftward force applied by the solenoid 40 to the control valve body 22 increases in proportion to the current amount.

Conversely, when the current amount supplied to the solenoid 40 is decreased from the state where the first movable iron core 45 is adsorbed to the first fixed iron core 43 and the pressing force of the spring 47 is not transmitted to the second movable iron core 46, the rightward force in FIG. 6 that attracts the first movable iron core 45 to the first fixed iron core 43 decreases, and the leftward force in FIG. 6 that attracts the second movable iron core 46 to the second fixed iron core 44 also decreases. Even in such a case, in the region where the current amount supplied to the solenoid 40 is the current amount Ib or more, the state in which the first movable iron core 45 is adsorbed to the first fixed iron core 43 and the pressing force of the spring 47 is not transmitted to the second movable iron core 46 is maintained. Therefore, in the region where the current amount supplied to the solenoid 40 is the current amount Ib or more, as the current amount supplied to the solenoid 40 decreases, the leftward force applied by the solenoid 40 to the control valve body 22 decreases in proportion to the current amount.

Meanwhile, in the case where the current amount supplied to the solenoid 40 is decreased from the state where the first movable iron core 45 is adsorbed to the first fixed iron core 43 and the pressing force of the spring 47 is not transmitted to the second movable iron core 46, in the region where the current amount becomes less than the current amount Ib, the pressing force of the spring 47 releases the adsorption state of the first movable iron core 45 and the first fixed iron core 43, and the pressing force of the spring 47 is transmitted to the second movable iron core 46. Therefore, in the region where the current amount is less than the current amount Ib, as the current amount supplied to the solenoid 40 decreases, the leftward force in FIG. 6 applied by the solenoid 40 to the control valve body 22 increases.

As can be seen from FIG. 7, Ib, which is the minimum current amount required to maintain the adsorption of the first movable iron core 45 and the first fixed iron core 43, is smaller than the current amount Ia, which is the minimum current amount required to adsorb the separated first movable iron core 45 to the first fixed iron core 43 (Ia>Ib). Therefore, the characteristic of the force applied by the solenoid 40 to the control valve body 22 with respect to the current amount supplied to the solenoid 40 has hysteresis. Note that in FIG. 7, in order to facilitate understanding, the region where the current amount supplied to the solenoid 40 is small is exaggerated.

In the present embodiment, when the current amount supplied to the solenoid 40 is controlled to control the force applied by the solenoid 40 to the control valve body 22, after once supplying a current equal to or larger than the current amount Ia and adsorbing the first movable iron core 45 to the first fixed iron core 43, the current amount supplied to the solenoid 40 is controlled in a range of the current amount Ic or more, which is larger than the current amount Ib. Once the first movable iron core 45 is adsorbed to the first fixed iron core 43, unless the current amount supplied to the solenoid 40 becomes less than Ib, the first movable iron core 45 will not separate from the first fixed iron core 43, and therefore the current amount Ic may be less than the current amount Ia as long as the current amount Ic is larger than the current amount Ib. Accordingly, in normal times when the current amount passing through the solenoid 40 is controlled, the state where the first movable iron core 45 is adsorbed to the first fixed iron core 43 is maintained. Therefore, the current amount supplied to the solenoid 40 and the leftward force applied by the solenoid 40 to the control valve body 22 in FIG. 6 are in a proportional relationship, and the force increases as the current amount supplied to the solenoid 40 increases.

In normal times (during control), the force applied by the solenoid 40 to the control valve body 22 caused by the magnetic force generated by the passage of current through the solenoid 40 is referred to as “driving force” of the solenoid 40. That is, the driving force of the solenoid 40 is controlled by controlling the current amount supplied to the solenoid 40. In the present embodiment, the current amount supplied to the solenoid 40 and the driving force applied to the control valve body 22 by the solenoid 40 have a proportional relationship. The driving force increases as the supply current amount increases, and the driving force decreases as the supply current amount decreases.

Meanwhile, at the time of failure when the passage of current through the solenoid 40 is cut off, which is the same situation as when no current passes, the control valve body 22 is pressed leftward in FIG. 6 by the spring 47 of the solenoid 40, and the pressing force is determined in advance according to the specification of the spring 47 such as the spring constant. The direction of the pressing force of the spring 47 that presses the control valve body 22 at the time of failure (when no current passes) is the same as the direction of the driving force applied to the control valve body 22 in normal times. Note that the pressing force of the spring 47 when the passage of current to the solenoid 40 is cut off is larger than the pressing force by which the coil spring 33 separates the control valve body 22 from the valve seat member 21. Therefore, the solenoid 40 can exert the driving force to cause the control valve body 22 to sit on the valve seat member 21 against the coil spring 33 even when no current passes.

In this way, in normal times, the driving force of the solenoid 40 is controlled such that the current amount supplied to the coil 41 of the solenoid 40 is larger than or equal to the current amount Ic, and the driving force increases as the current amount increases. That is, when the current amount to the solenoid 40 increases, the driving force of the solenoid 40 pushing the control valve body 22 in the direction of closing the valve against the coil spring 33 increases, and thus the valve opening pressure of the control valve 24 increases. Therefore, in normal times, when the current amount passing through the solenoid 40 is the current amount Ic, the valve opening pressure of the control valve 24 is the smallest, the back pressure chamber 5 has the lowest pressure, and the valve opening pressure of the leaf valve 3 is the lowest. Meanwhile, when the current amount passing through the solenoid 40 becomes maximum, the valve opening pressure of the control valve 24 becomes highest, the back pressure chamber 5 has the highest pressure, and the valve opening pressure of the leaf valve 3 becomes highest. Note that the maximum current amount passing through the solenoid 40 is appropriately determined according to the specifications of the coil 41, the power supply, and the like.

At the time of failure, as described above, the solenoid 40 transfers the pressing force of the spring 47 to the control valve body 22 to give the driving force opposite the coil spring 33. Therefore, at the time of failure, since the control valve body 22 is pressed against the valve seat member 21 with force of the pressing force of the spring 47 minus the pressing force of the coil spring 33, the valve opening pressure of the control valve 24 is determined according to the specifications of the spring 47 and the coil spring 33 such as the spring constant. Therefore, even at the time of failure, the valve opening pressure of the control valve 24 can be set in advance, and the valve opening pressure of the leaf valve 3 can be arbitrarily set by setting the pressure of the back pressure chamber 5 to the previously set valve opening pressure.

The following describes the operation of the damping valve 1 and the shock absorber 100 including the damping valve 1 according to the present embodiment. When the shock absorber 100 expands and contracts and the hydraulic oil is discharged from the extension side chamber 104 through the damping valve 1 to the reservoir 108, in a case where the damping valve 1 operates normally, the pressure upstream of the passage 10e and the pilot passage 23 increases. When a current is supplied to the solenoid 40 to adjust the valve opening pressure of the control valve 24, the pressure between the orifice 10d in the pilot passage 23 and the control valve 24 is led to the back pressure chamber 5.

The internal pressure of the back pressure chamber 5 is controlled by the valve opening pressure of the control valve 24, the pressure acting on the back of the leaf valve 3 can be adjusted by adjusting the valve opening pressure with the solenoid 40, and furthermore, the valve opening pressure by which the leaf valve 3 opens the passage 10e can be controlled.

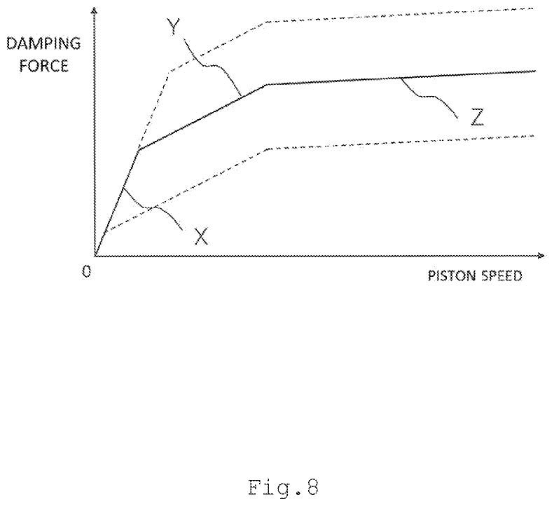

In more detail, when the pressure within the intermediate chamber 9 is increased by the pressure within the extension side chamber 104 and the force to deflect the outer circumference of the leaf valve 3 rightward in FIG. 3 overcomes the internal pressure of the back pressure chamber 5 and the pressing force by the leaf spring 7, the leaf valve 3 deflects and leaves the valve seat 2b, forming a gap between the leaf valve 3 and the disk 2, opening the passage 10e. Therefore, adjustment of the pressure in the back pressure chamber 5 in magnitude by the control valve 24 allows the pressure in the intermediate chamber 9 that can cause the leaf valve 3 to leave the valve seat 2b to be adjusted in magnitude. That is, the valve opening pressure of the leaf valve 3 can be controlled by the current amount applied to the solenoid 40. Therefore, as illustrated in FIG. 8, the damping force characteristic of the shock absorber 100 (characteristic of damping force with respect to the piston speed) shows a characteristic with a large damping coefficient (line X in FIG. 8) until the leaf valve 3 is opened because the hydraulic oil passes through the sliding gap of the damping valve 1 and the notch orifice 2d. When the leaf valve 3 leaves the valve seat 2b and opens the passage 10e, the damping force characteristic shows a characteristic of decreasing inclination, that is, decreasing damping coefficient, as indicated by the line Y in FIG. 8.

As described above, since the pressure intensification ratio in the leaf valve 3 is smaller than the pressure intensification ratio in the disk 2 and the valve opening pressure of the leaf valve 3 is smaller than the valve opening pressure of the disk 2, if the differential pressure generated by the port 2a does not reach the valve opening pressure that causes the disk 2 to leave the base portion 10a, the disk 2 will remain seated on the base portion 10a. Meanwhile, if the leaf valve 3 deflects to be in a valve open state, the piston speed of the shock absorber 100 increases, and the differential pressure generated by the port 2a reaches the valve opening pressure that causes the disk 2 to leave the base portion 10a, then the disk 2 will also leave the base portion 10a and open the passage 10e. Then, compared with the case where only the leaf valve 3 is in the valve open state and the passage 10e communicates with the reservoir 108 via the port 2a only, when the disk 2 leaves the base portion 10a, the passage 10e directly communicates with the reservoir 108 without via the port 2a and the channel area increases. Therefore, the damping force characteristic of the shock absorber 100 has a smaller inclination than when only the leaf valve 3 is in the valve open state as indicated by the line Z in FIG. 8, that is, the damping coefficient is even smaller.

Then, when the current amount to the solenoid 40 is adjusted and the valve opening pressure of the control valve 24 is increased or decreased, the damping force characteristic of the shock absorber 100 can be changed so as to move the line Y and the line Z up or down in the range indicated by the dashed lines in FIG. 8.

The pressure intensification ratio in the leaf valve 3 can be smaller than the pressure intensification ratio in the disk 2, whereby the valve opening pressure of the leaf valve 3 is smaller than the valve opening pressure of the disk 2, and the passage 10e is relieved in two stages. Therefore, the damping valve 1 can decrease the damping force at full soft time that minimizes the valve opening pressure of the control valve 24, and can increase the variable range of the damping force.

Therefore, the damping valve 1 of the present embodiment can output small damping force when the piston speed of the shock absorber 100 is in the low speed range without excessive damping force, and can also increase the upper limit of hard damping force requested when the piston speed is in the high speed range without causing insufficient damping force. Therefore, applying the damping valve 1 to the shock absorber 100 allows the damping force variable range to be increased and ride quality in a vehicle to be improved.

Note that in the present embodiment, the control valve 24 includes: the valve seat member 21 including the tubular small-diameter cylindrical portion 21a including the through-hole 21d that causes the inside and outside to communicate with each other, and the annular control valve seat 21f provided at the end of the small-diameter cylindrical portion 21a; and the control valve body 22 including the small-diameter portion 22a slidably inserted into the small-diameter cylindrical portion 21a, the large-diameter portion 22b, and the recess 22c provided between the small-diameter portion 22a and the large-diameter portion 22b and facing the through-hole 21d. The end of the large-diameter portion 22b in the control valve body 22 leaves and sits on the control valve seat 21f. Therefore, the control valve 24 can reduce the pressure receiving area where pressure acts in the direction in which the control valve body 22 exits the valve seat member 21, and can increase the channel area when the valve is open while reducing the pressure receiving area. With this configuration, the pressure receiving area of the control valve body 22 can be reduced to reduce the driving force that the solenoid 40 should output, and by increasing the channel area when opening the valve, the amount of movement of the control valve body 22 can be reduced and overshoot when the control valve 24 opens excessively can be reduced.

At the time of failure, the current supply to the solenoid 40 is cut off, but the solenoid 40 includes the first movable iron core 45 and the second movable iron core 46, and can apply the driving force to the control valve body 22 by the spring 47 even when no current passes in the same direction as when a current passes. Therefore, the damping valve 1 of the present embodiment sets the valve opening pressure of the leaf valve 3 to an arbitrarily preset value by causing the solenoid 40 to exert driving force even at the time of failure, and allows the shock absorber 100 to exert sufficient damping force.

Note that with a general pull-type solenoid that cannot apply driving force to the control valve body 22 at the time of failure, the pressure in the back pressure chamber 5 is extremely low, the valve opening pressure of the leaf valve 3 is also extremely low, resulting in insufficient damping force of the shock absorber. Therefore, when using such a solenoid, the structure of the damping valve becomes complicated, for example, a separate fail valve is required to increase the pressure in the back pressure chamber 5 at the time of failure. In contrast, the damping valve 1 of the present embodiment can cause the shock absorber 100 to exert preset damping force at the time of failure without requiring installation of a separate fail valve.

With a general push-type solenoid that applies maximum driving force to the control valve body 22 at the time of failure, the pressure in the back pressure chamber 5 is maximum, the valve opening pressure of the leaf valve 3 is also maximum, resulting in excessive damping force of the shock absorber. Therefore, when using such a solenoid, the structure of the damping valve is complicated, for example, a separate fail valve is required to make the pressure in the back pressure chamber 5 appropriate at the time of failure. In contrast, the damping valve 1 of the present embodiment can cause the shock absorber 100 to exert preset damping force at the time of failure without requiring installation of a separate fail valve.

The damping valve 1 and the shock absorber 100 operate as described above. The damping valve 1 of the present embodiment includes the disk 2 with the port 2a and the valve seat 2b surrounding the port 2a, the leaf valve 3 that opens and closes the port 2a by causing the front side to sit on and leave the valve seat 2b, the tubular housing 4 provided on the back side of the leaf valve 3, the annular spool 6 that abuts on the back of the leaf valve 3 and is slidably inserted into the inner circumference of the housing 4 to form the back pressure chamber 5 that causes the back pressure to act on the leaf valve 3 inwardly together with the housing 4, the annular spring support portion 4g that is located on the back side of the leaf valve 3, faces the inside of the back pressure chamber 5, and has a smaller outer diameter than the inner diameter of the spool 6, and the annular leaf spring 7 that is interposed between one end of the spool 6 that is the opposite end of the leaf valve and the spring support portion 4g and presses the spool 6 in a direction of abutting on the leaf valve 3.

In the damping valve 1 configured in this way, the spool 6 is disposed in the inner circumference of the housing 4 to allow the spool 6 to have a smaller inner and outer diameter, and the leaf spring 7 pressing the spool 6 is supported by the opposite end of the leaf valve of the spool 6, eliminating the need to provide the spring seat that supports the leaf spring 7 in the inner circumference of the spool 6. Therefore, since the damping valve 1 of the present embodiment can reduce the inertial mass of the spool 6 by reducing the volume of the spool 6, the influence of the inertia of the spool 6 when opening and closing the leaf valve 3 is reduced, and the responsiveness can be improved for the opening and closing operation of the leaf valve 3.

In the damping valve 1 of the present embodiment, the spring support portion 4g faces the back of the leaf valve 3 and abuts only on the opposite side of the leaf valve of the inner circumferential end of the leaf spring 7. In the damping valve 1 configured in this way, since only the inner circumference of the leaf spring 7 on the opposite side of the leaf valve abuts on the spring support portion 4g facing the back of the leaf valve 3 and the inner circumference of the leaf spring 7 is not fixedly supported by the housing 4, the total deflection amount of the leaf spring 7 with respect to the amount of movement of the spool 6 can be reduced, and the apparent spring constant of the leaf spring 7 can be made low. Here, when trying to further reduce the inertial mass of the spool 6, the inner and outer diameters of the spool 6 will be reduced, but as a result, the difference between the inner and outer diameters of the leaf spring 7 decreases, the spring constant increases, and the valve opening pressure of the leaf valve 3 varies from product to product, leading to an antinomy. However, since the damping valve 1 of the present embodiment can reduce the apparent spring constant of the leaf spring 7 and reduce the influence of the leaf spring 7 on the opening pressure of the leaf valve 3, even if the inner and outer diameters of the spool 6 are reduced and the inertial mass is reduced accordingly, it is possible to prevent variations in the damping force. That is, the damping valve 1 configured in this way can further reduce the inertial mass of the spool 6 and further improve the responsiveness in the opening and closing operation of the leaf valve 3.

Furthermore, the damping valve 1 of the present embodiment is configured such that the spool 6 includes the tapered portion 6b inside the first-end outer circumferential portion 6a that is outer circumference of one end, and that the leaf spring 7 abuts on the spool 6 only at the first-end outer circumferential portion 6a. The damping valve 1 configured in this way can increase the supporting diameter of the leaf spring 7 on the outer circumferential side, and can reduce the deflection amount of the leaf spring 7. Therefore, by providing the tapered portion 6b inside the first-end outer circumferential portion 6a of the spool 6 in this way, the apparent spring constant of the leaf spring 7 can be reduced. Therefore, the damping valve 1 configured in this way can further reduce the inertial mass of the spool 6 and further improve the responsiveness in the opening and closing operation of the leaf valve 3, as in the case where the inner circumference of the leaf spring 7 is not fixedly supported as described above.

In addition, the damping valve 1 of the present embodiment is configured such that the spool 6 includes the tapered portion 6d inside the second-end outer circumferential portion 6c, which is the outer circumferential portion at the second end that is the leaf valve side end, and that the leaf valve 3 abuts only on the second-end outer circumferential portion 6c of the spool 6. The damping valve 1 configured in this way allows higher degree of flexibility in the selection of the number of annular plates and the outer diameter of the leaf valve 3 because the spool 6 does not interfere with the leaf valve 3 even if the leaf valve 3 deflects thanks to the tapered portion 6d of the spool 6.

The damping valve 1 of the present embodiment includes the pilot passage 23 that causes the inside of the back pressure chamber 5 to communicate with the upstream side of the port 2a, and the control valve 24 that controls the pressure in the back pressure chamber 5. The damping valve 1 configured in this way can adjust the damping force of the shock absorber 100 by adjusting the pressure in the back pressure chamber 5 with the control valve 24 and changing the valve opening pressure of the leaf valve 3. In this embodiment, the orifice 10d is provided in the pilot passage 23 to reduce the pressure in the passage 10e and introduce the pressure into the back pressure chamber 5, but in addition to the orifice, other valves such as a choke may be used to reduce the pressure.

Note that the damping valve 1 of the present embodiment controls the pressure in the back pressure chamber 5 with the solenoid 40 to control the valve opening pressure of the disk 2 and the leaf valve 3. However, even if the solenoid 40 does not control the valve opening pressure of the control valve 24 and the control valve 24 does not control the pressure of the back pressure chamber 5 as a passive pressure control valve, the pressure intensification ratio in the leaf valve 3 can be made smaller than the pressure intensification ratio in the disk 2. Therefore, the damping characteristic can be changed in two stages, small damping force can be output without excessive damping force when the piston speed is in a low speed range, large damping force can be output when the piston speed reaches a high speed range, and insufficient damping force can be solved.

Furthermore, since the disk 2 is stacked in a floating state with respect to the valve holding member 10, the passage 10e can be greatly opened, and the damping coefficient when the valve of the disk 2 is open can be reduced, greatly facilitating the damping force control by the solenoid 40. Since the leaf valve 3 is an annular leaf valve with the inner circumference fixed to the valve holding member 10 and the outer circumference leaving and sitting on the valve seat 2b, even if the disk 2 is provided and the damping force is changed in two stages, after the leaf valve 3 presses the disk 2 and the disk 2 releases the passage 10e, returning to a position to sit on the base portion 10a is helped. Therefore, there is no delay in closing the passage 10e when the expansion and contraction direction of the shock absorber 100 is switched, and the responsiveness of damping force generation is not impaired.

The shock absorber 100 of the present embodiment includes the cylinder 101, the piston 102 that is movably inserted into the cylinder 101 and divides the cylinder 101 into the extension side chamber 104 and the compression side chamber 105 that are filled with liquid, the rod 103 connected to the piston 102, the reservoir 108 storing the liquid, the suction passage 110 that only allows the flow of hydraulic oil from the reservoir 108 to the compression side chamber 105, the rectifying passage 111 that allows only the flow of hydraulic oil from the compression side chamber 105 to the extension side chamber 104, the discharge passage 106 that causes the extension side chamber 104 to communicate with the reservoir 108, and the damping valve 1 provided in the discharge passage 106 with the extension side chamber 104 as upstream of the port 2a and the reservoir 108 as downstream of the port 2a.

The shock absorber 100 configured in this way is configured as a uniflow shock absorber in which liquid is always discharged from within the cylinder 101 through the discharge passage 106 to the reservoir 108 when expanding or contracting, and one responsive damping valve 1 gives resistance to the liquid flow, improving the responsiveness of damping force generation.

Note that when applied to the uniflow shock absorber 100 in this way, the damping valve 1 can improve the responsiveness of damping force generation regardless of the direction of expansion or contraction of the shock absorber 100, but may be applied to a bi-flow shock absorber. The bi-flow shock absorber includes a single-tube shock absorber with an air chamber inside the cylinder and a twin-tube shock absorber with a reservoir outside the cylinder. In the single-tube shock absorber, the piston includes an extension side passage that allows the liquid flow from an extension side chamber to a compression side chamber, and a compression side passage that allows the liquid flow from the compression side chamber to the extension side chamber. In the twin-tube shock absorber, in addition to these extension side passage and the compression side passage, the piston includes a suction passage allows the liquid flow from a reservoir disposed outside the cylinder to the compression side chamber, and a discharge passage that allows the liquid flow from the compression side chamber to the reservoir. The damping valve 1 including the solenoid 40 can be installed in any of the extension side passage, compression side passage, and discharge passage. The shock absorber including the damping valve 1 in this way can adjust in magnitude the damping force generated by changing the current amount supplied to the solenoid 40, and can improve the responsiveness of damping force generation.

The damping valve 1 of the present embodiment changes the damping force in two steps by the leaf valve 3 opening and closing the port 2a of the disk 2 that opens and closes the passage 10e provided in the base portion 10a of the valve holding member 10. However, if there is no need to change the damping force in two steps, the following structure may be adopted in which the disk 2 is abolished and the base portion 10a of the valve holding member 10 is used as the disk, the passage 10e of the base portion 10a is used as the port, the base portion 10a is provided with a valve seat surrounding the passage 10e, and the passage 10e is opened and closed by the leaf valve 3.

Although the preferred embodiment of the present invention has been described above in detail, modifications, variations, and changes are still possible without departing from the scope of the claims.

The present application claims priority based on Japanese Patent Application No. 2020-163068 filed with the Japanese Patent Office on Sep. 29, 2020, and the entire contents of this application are incorporated into the present specification by reference.

1. A damping valve comprising:
a disk with a port and a valve seat surrounding the port;
a leaf valve that opens and closes the port by causing a front side to sit on and leave the valve seat;
a tubular housing provided on a back side of the leaf valve;
an annular spool that abuts on the back of the leaf valve and is slidably inserted into inner circumference of the housing to form a back pressure chamber that causes back pressure to act on the leaf valve inwardly together with the housing;
an annular spring support portion that is located on the back side of the leaf valve, faces inside of the back pressure chamber, and has a smaller outer diameter than an inner diameter of the spool; and
an annular leaf spring that is interposed between one end of the spool that is an opposite side end of the leaf valve and the spring support portion, and presses the spool in a direction of abutting on the leaf valve.

2. The damping valve according to claim 1, wherein
the spring support portion faces the back of the leaf valve and abuts only on the opposite side of the leaf valve of an inner circumferential end of the leaf spring.

3. The damping valve according to claim 1, wherein
the spool includes a tapered portion inside a first-end outer circumferential portion that is an outer circumferential portion of the one end, and
the leaf spring abuts on the spool only at the first-end outer circumferential portion.

4. The damping valve according to claim 1, wherein
the spool includes a tapered portion inside a second-end outer circumferential portion that is an outer circumferential portion at a second-end that is a leaf valve side end, and
the leaf valve abuts only on the second-end outer circumferential portion of the spool.

5. The damping valve according to claim 1, further comprising:
a pilot passage that causes inside of the back pressure chamber to communicate with an upstream side of the port, and
a control valve that controls pressure in the back pressure chamber.

6. A shock absorber comprising:
a cylinder;
a piston that is movably inserted into the cylinder and divides the cylinder into an extension side chamber and a compression side chamber filled with liquid;
a rod connected to the piston;
a reservoir that stores the liquid;
a rectifying passage that allows only a flow of the liquid from the compression side chamber to the extension side chamber;
a suction passage that allows only a flow of the liquid from the reservoir to the compression side chamber;
a discharge passage that causes the extension side chamber to communicate with the reservoir; and
the damping valve according to claim 1 that is provided in the discharge passage with the extension side chamber as upstream of the port and the reservoir as downstream of the port.
